(19) United States
(12) Patent Application Publication
(10) Pub. No.: US 2005/0043995 A1
(43) Pub. Date: Feb. 24, 2005

(54) Discount coupon usage

(76) Inventor: Martin Khang Nguyen, Westminster, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/953,009

(22) Filed: Sep. 29, 2004

Related U.S. Application Data
(63) Continuation-in-part of application No. 10/461,556, filed on Jun. 12, 2003.
Application No. 10/461,556 is a continuation-in-part of application No. 09/931,677, filed on Aug. 15, 2001.
Application No. 10/461,556 is a continuation-in-part of application No. 10/211,386, filed on Aug. 2, 2002.

(51) Int. Cl. G06F 17/60; G06G 1/12

(52) U.S. Cl. 705/14; 705/21

(57) ABSTRACT

An embodiment of the present invention includes a receiver and a processing unit. The receiver receives merchandise information on a merchandise having a merchandise radio frequency identification (RFID) tag when a user is within a distance from the merchandise. The merchandise information is transmitted from a module in a wireless transmission. The module has a RFID reader to read the merchandise RFID tag and retrieves the merchandise information from a merchandise database based on the merchandise RFID tag. The processing unit is coupled to the receiver to inform the user of the merchandise information.

### RELATED APPLICATIONS

The present application claims priority, as a continuation-in-part (CIP) application, of the following application: Title “Coupon Rebate Business Method Using Portable Personal Communication Devices”, filed Jun. 12, 2003, Ser. No. 10/461,556, which is a continuation-in-part (CIP) application of (1) Title: “Discount Purchase Business Method”, filed Aug. 15, 2001, Ser. No. 09/931,677, (2) Title: “Internet Related Discount Coupon Rebate Business Method”, filed Aug. 2, 2002, Ser. No. 10/211,386, and the contents of which are hereby incorporated by reference in their entirety.

### BACKGROUND

1. Field of the Invention

Embodiments of the invention relates to the field of marketing products, and more specifically, to merchandise information.

2. Description of Related Art

One main objective of product marketing is to provide merchandise information to consumers in an efficient manner. Merchandise information includes product highlights, promotional programs such as discount and rebates. Discount coupons or rebates are available to provide consumers reduced purchase prices. Discount coupons or rebates are a form of marketing devices to attract consumers to buy merchandises.

Existing techniques to provide merchandise information, especially discount coupons or rebates, are typically inefficient and cumbersome. Most discount coupons or rebates are available in printed forms published in newspapers or magazines, or in advertisements. Many consumers do not read newspapers or magazines and therefore are not aware of the available discount coupons or rebates. Furthermore, printed coupons require the consumers to cut out the coupons and carry with them to the retailers. Consumers sometimes have to save several coupons and present them at the check-out stand, causing delay and inconvenience to other patrons. In addition, duplicates, copied, or fraudulent coupons may be presented, causing losses to the manufacturers.

### BRIEF DESCRIPTION OF THE DRAWINGS

Embodiments of the invention may best be understood by referring to the following description and accompanying drawings that are used to illustrate embodiments of the invention. In the drawings:

FIG. 1 is a diagram illustrating a system in which one embodiment of the invention can be practiced.

FIG. 2 is a diagram illustrating a retailer set-up according to one embodiment of the invention.

FIG. 3 is a diagram illustrating a communication device according to one embodiment of the invention.

FIG. 4 is a flowchart illustrating a process to transmit merchandise information to user communication device according to one embodiment of the invention.

FIG. 5 is a flowchart illustrating a process to inform user of the merchandise information according to one embodiment of the invention.

FIG. 6 is a diagram illustrating a coupon according to one embodiment of the invention.

### DESCRIPTION

An embodiment of the present invention includes a receiver and a processing unit. The receiver receives merchandise information on a merchandise having a merchandise radio frequency identification (RFID) tag when a user is within a distance from the merchandise. The merchandise information is transmitted from a module in a wireless transmission. The module has a RFID reader to read the merchandise RFID tag and retrieves the merchandise information from a merchandise database based on the merchandise RFID tag. The processing unit is coupled to the receiver to inform the user of the merchandise information.

In another embodiment of the invention, a coupon includes a merchandise identifier and a coupon identifier. The merchandise identifier identifies a merchandise having a discount. The coupon identifier identifies the coupon. The coupon identifier is used to determine frequency of usage of the coupon when presented to redeem for the discount of the merchandise.

In the following description, numerous specific details are set forth. However, it is understood that embodiments of the invention may be practiced without these specific details. In other instances, well-known circuits, structures, and techniques have not been shown in order not to obscure the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

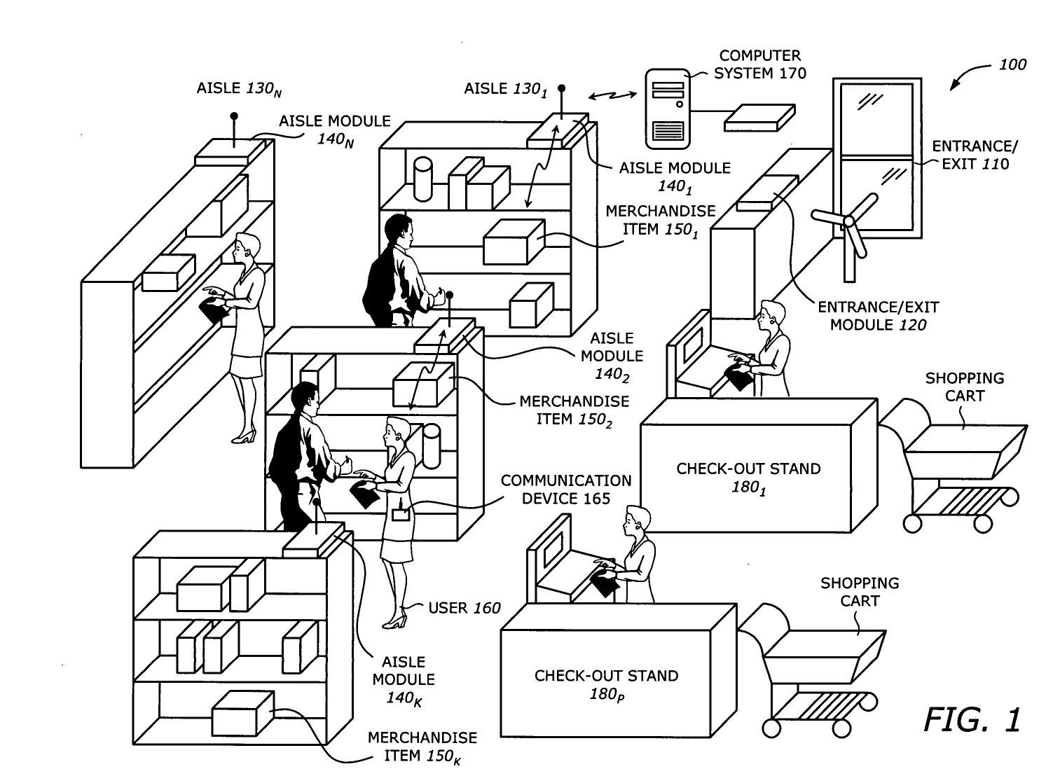

FIG. 1 is a diagram illustrating a system 100 in which one embodiment of the invention can be practiced. The system 100 represents a typical selling entity such as a retailer or a wholesaler. The selling entity may be a member of a business system that provides discount coupon services to consumers. The selling entity may be a retail store, a supermarket, a grocery store, a shopping mall boutique, a department store, etc. The system 100 includes an entrance/exit 110, an entrance/exit module 120, aisles 130₁ to 130_{N}, aisle modules 140₁ to 140_{N}, merchandise items 150₁ to 150_{K}, a user 160, a communication device 165, a computer system 170, and check-out stands 180₁ to 180_{P}. Note that the system 100 may include more or less than the above components.

The entrance/exit module 120 is typically installed near the entrance/exit 110 at a location where all customers have to pass through when entering or exiting the retailer facility. The entrance/exit module 120 essentially includes a radio frequency identification (RFID) reader that reads the user RFID tag attached to the communication device 165 carried by the user 160. The entrance/exit module 120 is optional and is used when it is expected there may be users who carry communication devices that have user RFID tags. The entrance/exit module 120 is communicatively coupled to the computer system 170, either by wired or wireless connectivity. A typical wireless connectivity may be radio frequency (RF) connectivity, Bluetooth, optical connectivity (e.g., infrared), or ultrasound connectivity. The entrance/exit module 120 transmits the user RFID tag to the computer system 170. The computer system 170 then retrieves user information from a user database and may transmit information on the merchandises to the communication device 165.

The aisles 130₁ to 130_{N} include shelves or storage to store and display merchandise items 150₁ to 150_{L}. Typically the aisles 130₁ to 130_{N} are arranged to display merchandise items 150₁ to 150_{L} according to their categories. For example, an aisle labeled Oral Hygiene may display merchandises such as toothbrush, toothpaste, floss, mouthwash products, etc. Each of the merchandise items 150₁ to 150_{L} may contain a merchandise RFID tag which identifies the merchandise.

The aisle modules 140₁ to 140_{K} are modules that can read the merchandise RFID tags within their range. They are communicatively coupled to the computer system 170 either through wired or wireless connectivity similar to the entrance/exit 120.

The user 160 is a person who is a member of the commercial business system that provides discount coupon services or who has the communication device 165. The user 160 may have registered to the business system and have user information stored in the user database of the business system. The user information may include user identification, a user profile, and other relevant information such as purchase habit, account information, credit balance, discount privilege level, etc. The user 160 carries the communication device 165. In another embodiment, the user 160 may carry a coupon corresponding to the merchandise item with or without the communication device 165.

The communication device 165 is a device that communicates with the various modules in the selling entity and informs the user 160 of relevant merchandise information. The communication device 165 may be part of a cellular phone, a personal digital assistant (PDA), a watch, a palm computer, or a specially designed unit.

The computer system 170 is communicative coupled to the entrance/exit module 120 and the aisle modules 140₁ to 140_{N} via wired or wireless connectivity. Wireless transmissions may be used to allow communication between the various modules and the computer system 170. Wireless transmissions may include radio frequency (RF) transmission (e.g., Bluetooth, hotspot), infrared transmission, ultrasound transmission, etc. Typically, the computer system 170 is interfaced to a network as part of the commercial business system that provides the discount coupon services.

The check-out stands 180₁ to 180_{P} are places where the user 160 and other shoppers check out their purchases. Each of the check-out stands 180₁ to 180_{P} may have scanner, reader, or other device to read or scan the communication device 165 when the user 160 checks out his or her purchases.

In a typical scenario, the user 160 carries the communication device 165 enters the retailer store through the entrance/exit 110. The retail store may be a participant of the commercial business that provides the discount coupon services. Through this service, the user 160 may have registered and have a user identification. The user 160 may also have been issued a user RFID tag to be attached to the communication device or carried by the user 160. When the entrance/exit module 120 reads the user RFID tag whether attached to the communication device 165 or carried by the user 160, it transmits the information to the computer system 170. The computer system 170 then searches for additional user information, validates the user identification, and retrieves the user profile and other relevant information from a user database. The computer system 170 may then sends information regarding various merchandise items currently sold in the retailer based on the user profile. This information may include new products, discounts available for selected merchandise items, and other relevant information. The entrance/exit module 120 then sends this information to the communication device 165 to inform the user 160 of merchandise information. Therefore, upon entering the retailer facility, the user 160 may know what products are on sale, have discounts, or rebates. These products may be selected or tailored according to the user profile, such as past purchases, merchandise interests, or discount usage.

The user 160 may select a merchandise item on a list of merchandise items displayed on the communication device 165 to find out if there is any discount information. Alternatively, the user 160 may leave the communication device 165 on to automatically receive merchandise information whenever the user 160 is coming near the aisle where the merchandise is being displayed or shown.

As the user 160 walks through the retailer facility from aisle to aisle, the aisle modules 140₁ to 140_{K} continuously or periodically determines the location of the user 160. When the user 160 is within a predefined distance of a merchandise or a group of merchandises that have interesting merchandise information such as discount or rebate information, the corresponding aisle module 140ₖ transmits the merchandise information to the communication device 165 to inform the user 160 of this information. The predefined distance may correspond to the reading or transmitting range of the module 140, or the receiving and/or transmitting range of the communication device 165. By displaying the merchandise information when the user 160 approaches the merchandise, the level of the user's interest in purchasing the merchandise increases. The user 160 does not have to cut the discount coupon in advance. He or she can merely shows the communication device 165 or presents a form of identification indicating that he or she is a participant of the business system that offers the discount coupon services at the time he or she checks out the merchandise item at the check-out stand.

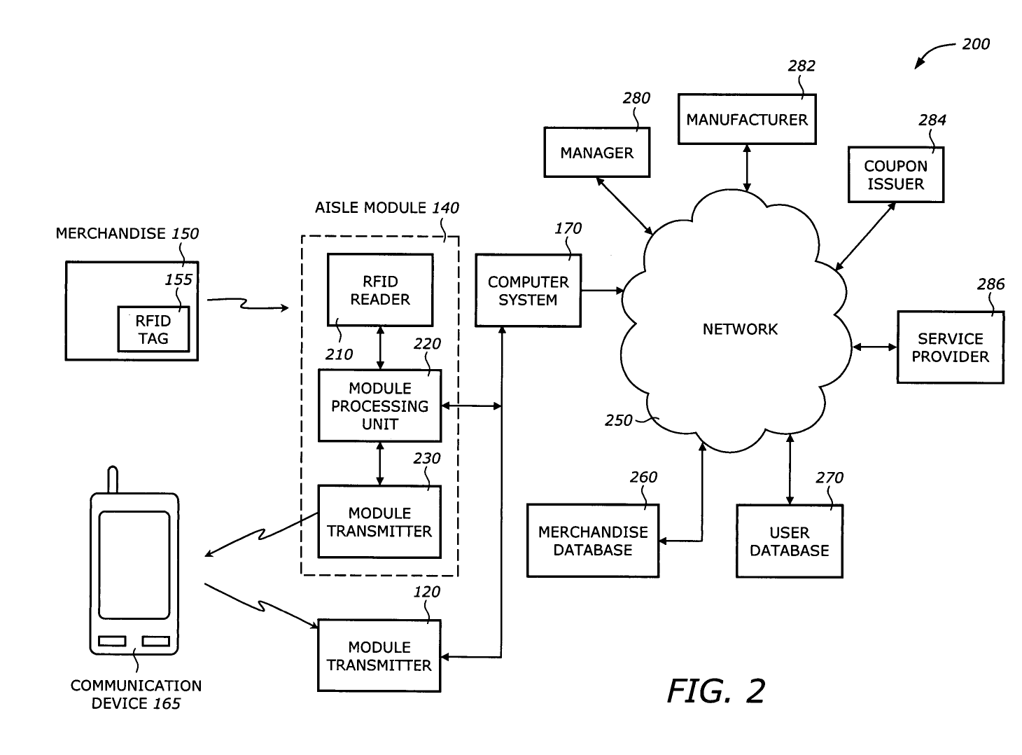

FIG. 2 is a diagram illustrating a store set-up 200 according to one embodiment of the invention. The set-up 200 includes the merchandise 150, the aisle module 140, the communication device 165, and the computer system 170.

The merchandise 150 has a merchandise RFID tag 155 which contains an identifier code for the merchandise. The merchandise RFID tag 155 may be a passive or an active tag operating at any suitable RF frequency compatible with the aisle module 140. In one embodiment, the merchandise 150 has promotional information such as discount or rebate information. The merchandise 150 is placed within an operating range of the aisle module 140.

The aisle module 140 includes a RFID reader 210, a module processing unit 220, and a module transmitter 230. The RFD reader 210 is capable of reading the merchandise RFID tag 155 within its range. The RFID reader 210 may read several merchandise RFID tags simultaneously from several merchandises 150's located within its range. Techniques such as collision avoidance may be employed to allow the RFID reader 210 to read unambiguously the merchandise RFID tags within its range.

The module processing unit 220 is a processor that is communicative coupled with the computer system 170, the RFID reader 210, and the module transmitter 230. The module processing unit 220 may include a processor (e.g., a general purpose processor, a single-chip microcontroller, a digital signal processor), a memory, an input/output device, and a communication interface device. It receives the merchandise RFID tag from the RFID reader 210, and sends it to the computer system 170. It also receives the merchandise information from the computer system 170 and sends to the transmitter 230. The merchandise information includes at least one of a discount information, a rebate information, a product information, a pricing information, a manufacturer information, a manager information, a coupon issuer information, and a service provider information. The discount information includes the discount value of the merchandise, an expiration date for the discount. The rebate information includes a rebate amount and the expiration of the rebate.

The module transmitter 230 receives the merchandise information from the module processing unit 220 and transmits it to the communication device 165. The transmitter 230 may operate using the same or different transmission medium with the RFID reader 210. It may transmit the merchandise information using radio frequency, electromagnetic signal, infrared, ultrasound, or any other wireless transmission techniques.

The communication device 165 receives the merchandise information and informs the user of the merchandise information either by displaying it on its display or generates audio signal to announce the information.

The computer system 170 is communicatively coupled to the aisle module 140 and the entrance/exit module 120 if available. It is connected to a network 250. The network 250 is any suitable network. It may be a local area network, a wide area network, a intranet, an extranet, or the Internet. The network 250 is also connected to a merchandise database 260 and a user database 270. It may also be connected to a manager 280, a manufacturer 282, a coupon issuer 284, and a service provider 286. The manager 280 may provide the communication device 165 and/or service to support this coupon usage to the user 160 for use in this commercial business system, and acts as a middle entity to pass the rebate from the manufacturer 282 to the retailer of the system 100. The communication device 165 may be provided by any party. The manufacturer 282 provides a rebate to the manager 280 or the retailer of the system 100. The coupon issuer 284 maintains coupons identifying the merchandise discount. The functions of the coupon issuer 284 may be performed by the manager 280. The service provider 286 is any commercial or business entity that provides service to the user or member of the system.

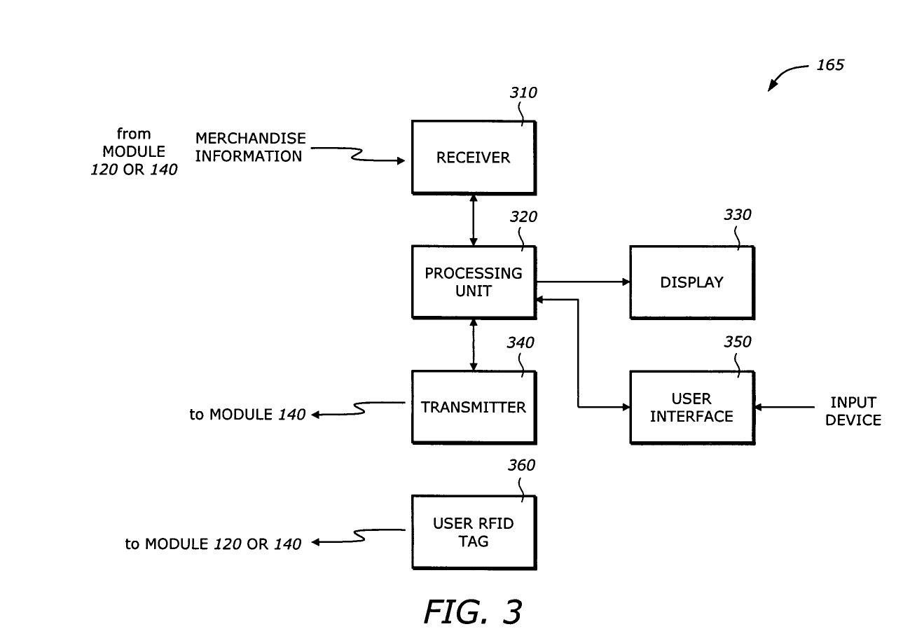

FIG. 3 is a diagram illustrating the communication device 165 according to one embodiment of the invention. The communication device 165 includes a receiver 310, a processing unit 320, a display 330, a transmitter 340, a user interface 350, and a user RFID tag 360. Note that the communication device 165 may contain more or less components than the above.

The receiver 310 receives the merchandise information sent by the aisle module 140 or the entrance/exit module 120. The receiver 310 typically operates in the same transmission mode as the transmitter 230 in the aisle module 140. The processing unit 320 processes the received merchandise information and informs the user 160 of the merchandise information, either by displaying the information on the display 330 or generates an audio signal. The display 330 may be a small display to display the merchandise information including the discount information and the rebate information. The merchandise information may be displayed in textual, iconic, pictorial, graphical, virtual, or imaging format, including a facsimile of a real coupon. The display 330 may also display soft keys to allow the user 160 to enter selection or choice. The transmitter 340 transmits the user information such as user identification, user profile, membership information, a value amount, and a discount privilege level, to the module 160. The transmitter 340 may be optional. The user interface 350 provides user interface such as inputting user's commands. It may include keyboard interface, pointing device (e.g., pen, trackball, mouse) interface. The user 160 may select a softkey displayed on the display as part of a graphical user's interface (GUI) when entering commands or data.

The user RFID tag 360 contains user identification or device identification that identifies the communication device 165 and/or the user 160. The user RFID tag 360 may be optional. It is typically read by the entrance/exit module 120 when the user 160 enters the retailer facility.

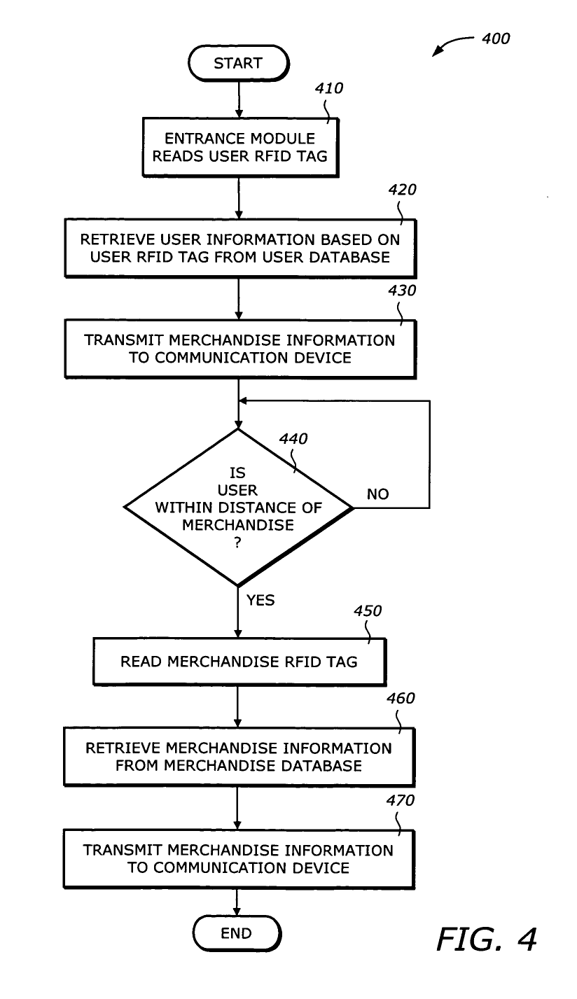

FIG. 4 is a flowchart illustrating a process 400 to transmit merchandise information to user communication device according to one embodiment of the invention.

Upon START, the process 400 reads the user RFID tag when the user enters the retailer facility (Block 410). Then, the process 400 retrieves the user information based on the user RFID tag from a user database (Block 420). The user information may include user identification, user profile, a value amount, discount privilege level, credit or debit balance, or any other relevant information. Next, the process 400 transmits the merchandise information to the communication device (Block 430). The merchandise information may include discount or rebate information of products in the retailer facility.

Next, the process 400 determines if the user is within a distance of a particular merchandise that has discount or rebate information or any other interesting promotional information. If not, the process 400 continues scanning or waits till the communication device or the aisle module establishes communication link. Otherwise, the process 400 reads the merchandise RFID tag of the particular merchandise or a group of merchandises that is within a distance of the user 160 (Block 450).

Then, the process 400 retrieves the merchandise information from a merchandise database (Block 460). Next, the process 400 transmits the merchandise information to the user communication device (Block 470) and is then terminated.

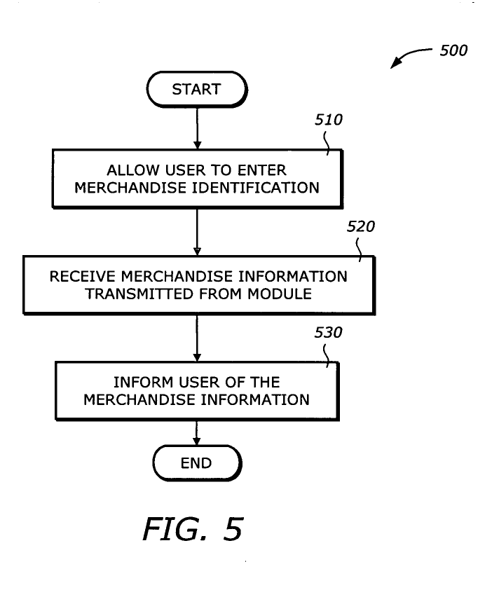

FIG. 5 is a flowchart illustrating a process 500 to inform user of the merchandise information according to one embodiment of the invention.

Upon START, the process 500 allows the user to enter merchandise information (Block 510). This can be performed by displaying a number of choices for merchandise on the display of the communication device. The user can select the merchandise of interest by pressing a key or a soft key on the display.

Next, the process 500 receives the merchandise information transmitted from an aisle module located at an aisle within a distance from the user (Block 520). Typically, this distance is within the range of operation of the communication device and/or the aisle module 140. Then, the process 500 informs the user of the merchandise information, either by displaying the information, or generating an audio signal announcing of the information (Block 530). The process 500 is then terminated.

The communication device 165 allows an efficient way to transmit and receive merchandise information. In the embodiments described above, it has a receiver and/or a transmitter to receive and/or transmit information. In other embodiments, it may be a wallet-sized card or a smart card that contains some unique identification code that identifies the user as a participant of the commercial business system.

In other embodiments, the user 160 may carry a coupon 600 corresponding to a merchandise item with or without the communication device 165. The coupon 600 may be obtained from the coupon issuer, the manager, or the manufacturer, via any suitable means, including newspapers, magazines, print-out from the Internet, or direct mailings.

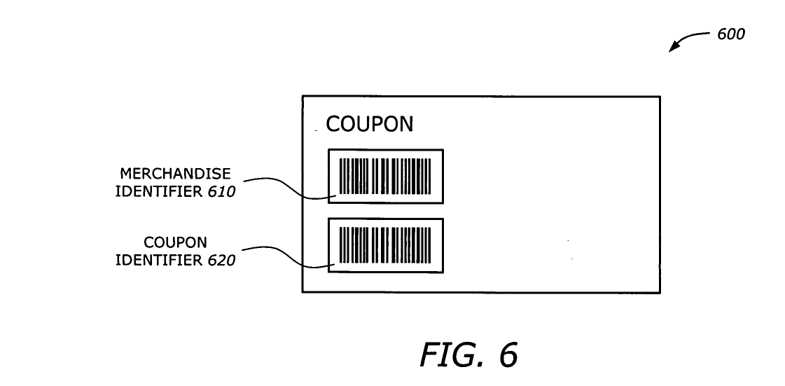

FIG. 6 is diagram illustrating a coupon 600 according to one embodiment of the invention. The coupon 600 has two identifiers: a merchandise identifier 610 and a coupon identifier 620. The merchandise identifier 610 is to identify the merchandise item associated with the discount or rebate. The coupon identifier 620 is to identify the coupon itself. The coupon identifier 620 is used to prevent duplicates, copied, or fraudulent coupon. By being able to identify a particular coupon that is presented, the retailer or the manager, the manufacturer, or the coupon issuer is able to determine the frequency of usage or how many times that particular coupon has been presented with or without within a pre-defined period of time (e.g., a week, a month). The identifiers 610 and 620 may be encoded using any suitable encoding techniques, such as bar code or RFID tag.

When the coupon 600 is presented to the retailer at the check out stand to redeem for the discount, it is scanned or read by a scanner or a reader. The information is then sent to the computer system 170. The computer system 170 then searches through its database, either available locally or remotely through the network 250 (FIG. 2) to determine how many times this particular coupon has been presented. Depending on the discount or rebate offers, the computer system 170 may sends a decision to the check-out cash register to notify the check-out clerk of the disposition of the coupon 600. The notification may also be printed on the purchase receipt or displayed on the cash register system.

There are a number of discount coupon usages that may be designed by the retailer, the manager, the manufacturer, or the coupon issuer. In the first usage, the coupon 600 may only be used once. Subsequent uses are rejected. The user 160 is notified of this decision when presenting the coupon. If it is determined that the coupon has already been used, the user 160 is informed that it is no longer valid. In the second usage, the coupon 600 may have gradually decreasing discount values each time it is presented. For example, the first use corresponds to a 100% value of the stated discount amount. The second use corresponds to a 80% value of the stated discount amount, etc. Any suitable decreasing percentages may be used. For multiple uses discount coupon, the coupon will be returned to the user 160 if it still has value other than 0% of the stated discount amount. When the coupon issued by a coupon issuer or a manufacturer can be honored by another retailer or a system with additional discount or rebate values, the gradual decrease is also carried over to these additional discount or rebate values.

Additional coupon usages may include scenarios such as returns and exchanges. When a merchandise purchased with a discount or rebate is returned, the retailer may return the out-of-pocket amount that was actually paid as shown on the receipt. If no receipt is presented, the retailer may not honor the return or may return to the purchaser the amount corresponding to the current price of the merchandise. A similar policy may be applied to exchanges. When the exchange is for a lesser priced item, the retailer return the difference between the two. For a higher priced item, the purchaser has to pay the difference.

Coupons may also be used as a promotional code. The code may be entered at the time a request for service or purchase is made. The promotional code may be provided to a targeted group of consumers. For example, an executive graduated from the University of Southern California (USC) may receive a promotional code for renting a car. When he or she rents a car, this promotional code may be presented to receive discount. In this scenario, the car rental company acts like the service provider 286 shown in FIG. 2 to provide a service to the consumer.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

1. An apparatus comprising:
a receiver to receive merchandise information on a merchandise having a merchandise radio frequency identification (RFID) tag when a user is within a distance from the merchandise, the merchandise information being transmitted from a module in a wireless transmission, the module having a RFID reader to read the merchandise RFID tag and retrieving the merchandise information from a merchandise database based on the merchandise RFID tag; and
a processing unit coupled to the receiver to inform the user of the merchandise information.

2. The apparatus of claim 1 wherein the merchandise information includes at least one of a discount information, a rebate information, a product information, and a pricing information.

3. The apparatus of claim 1 wherein the wireless transmission is one of a radio frequency (RF) transmission, an optical transmission, and an ultrasound transmission.

4. The apparatus of claim 1 wherein the processing unit comprises:
a display interface to provide the merchandise information to a display.

5. The apparatus of claim 1 further comprising:
a transmitter coupled to the processing unit to transmit user information to the module.

6. The apparatus of claim 1 wherein the user information includes at least one of identification information, membership information, a user profile, a value amount, and a discount privilege level.

7. The apparatus of claim 1 further comprising:
a user RFID tag to contain user identification information, the user identification information being transmitted to a RFID reader when the user is within a reading range of the RFID reader.

8. The apparatus of claim 7 wherein the module retrieves user information using the user identification information from a user database.

9. The apparatus of claim 8 wherein the module transmits other merchandise information to the receiver according to the user information.

10. The apparatus of claim 1 further comprising: a user interface to receive user input regarding the merchandise.

11. A method comprising:
receiving merchandise information on a merchandise having a merchandise radio frequency identification (RFID) tag when a user is within a distance from the merchandise by a receiver, the merchandise information being transmitted from a module in a wireless transmission, the module having a RFID reader to read the merchandise RFID tag and retrieving the merchandise information from a merchandise database based on the merchandise RFID tag; and
informing the user of the merchandise information.

12. The method of claim 11 wherein the merchandise information includes at least one of a discount information, a rebate information, a product information, and a pricing information.

13. The method of claim 11 wherein the wireless transmission is one of a radio frequency (RF) transmission, an optical transmission, and an ultrasound transmission.

14. The method of claim 11 wherein informing comprises:
providing the merchandise information to a display.

15. The method of claim 11 further comprising:
transmitting user information to the module.

16. The method of claim 11 wherein the user information includes at least one of identification information, membership information, a user profile, a value amount, and a discount privilege level.

17. The method of claim 11 further comprising:
transmitting user identification information encoded in a RFID tag to a RFID reader when the user is within a reading range of the RFID reader.

18. The method of claim 17 further comprising retrieving user information using the user identification information from a user database.

19. The method of claim 18 further comprising transmitting other merchandise information to the receiver according to the user information.

20. The method of claim 11 further comprising: a user interface to receive user input regarding the merchandise.

21. A system comprising:
a module; and
a communication device carried by a user communicatively coupled to the module, the communication device comprising:
a receiver to receive merchandise information on a merchandise having a merchandise radio frequency identification (RFID) tag when a user is within a distance from the merchandise, the merchandise information being transmitted from the module in a wireless transmission, the module having a RFID reader to read the merchandise RFID tag and retrieving the merchandise information from a merchandise database based on the merchandise RFID tag, and
a processing unit coupled to the receiver to inform the user of the merchandise information.

22. The system of claim 21 wherein the merchandise information includes at least one of a discount information, a rebate information, a product information, and a pricing information.

23. The system of claim 21 wherein the wireless transmission is one of a radio frequency (RF) transmission, an optical transmission, and an ultrasound transmission.

24. The system of claim 21 wherein the processing unit comprises:
a display interface to provide the merchandise information to a display.

25. The system of claim 21 wherein the communication device further comprises:
a transmitter coupled to the processing unit to transmit user information to the module.

26. The system of claim 21 wherein the user information includes at least one of identification information, membership information, a user profile, a value amount, and a discount privilege level.

27. The system of claim 21 the communication device further comprises:
a user RFID tag to contain user identification information, the user identification information being transmitted to a RFID reader when the user is within a reading range of the RFID reader.

28. The system of claim 27 wherein the module retrieves user information using the user identification information from a user database.

29. The system of claim 28 wherein the module transmits other merchandise information to the receiver according to the user information.

30. The system of claim 21 wherein the communication device further comprises: a user interface to receive user input regarding the merchandise.

31. A coupon comprising:
a merchandise identifier to identify a merchandise having a discount; and
a coupon identifier to identify the coupon, the coupon identifier being used to determine frequency of usage of the coupon when presented to redeem for the discount of the merchandise.

32. The coupon of claim 31 wherein at least one of the merchandise identifier and the coupon identifier is encoded by an encoding to be read by a reading device.

33. The coupon of claim 32 wherein the encoding is one of a bar code encoding and a RFID encoding.

34. The coupon of claim 32 wherein the reading device is one of a bar code reader and a RFID reader.

35. The coupon of claim 31 wherein the frequency of usage determines a discount value.

36. The coupon of claim 35 wherein the discount value is zero if the frequency of usage indicates that the coupon has been used at least once.

37. The coupon of claim 35 wherein the discount value is gradually decreasing according to the frequency of usage.

38. A method of using a coupon comprising:
identifying a merchandise having a discount by a merchandise identifier; and
identifying the coupon by a coupon identifier, the coupon identifier being used to determine frequency of usage of the coupon when presented to redeem for the discount of the merchandise.

39. The method of claim 38 wherein at least one of the merchandise identifier and the coupon identifier is encoded by an encoding to be read by a reading device.

40. The method of claim 39 wherein the encoding is one of a bar code encoding and a RFID encoding.

41. The method of claim 39 wherein the reading device is one of a bar code reader and a RFID reader.

42. The method of claim 38 wherein the frequency of usage determines a discount value.

43. The method of claim 42 wherein the discount value is zero if the frequency of usage indicates that the coupon has been used at least once.

44. The method of claim 42 wherein the discount value is gradually decreasing according to the frequency of usage.
